(19) United States
(12) Patent Application Publication
(10) Pub. No.: US 2010/0206488 A1
(43) Pub. Date: Aug. 19, 2010

(54) DISPENSER

(75) Inventors: Kinya Matsushita, Osaka (JP); Sachiko Miyano, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KOKUYO CO., LTD., Osaka-shi, Osaka (JP)

(21) Appl. No.: 12/676,468

(22) PCT Filed: Sep. 12, 2008
(86) PCT No.: PCT/JP2008/066538

§ 371 Date: Mar. 4, 2010

(30) Foreign Application Priority Data
Sep. 28, 2007 (JP) 2007-253112

(51) Int. Cl. B32B 37/00

(52) U.S. Cl. 156/391

(57) ABSTRACT

A dispenser 10 is configured to include: a case 13 including a trunk portion 11 for storing a transfer tape T and a neck portion 12 continued to the trunk portion 11; and a transfer head 14 that is placed on the forward end side of the neck portion 12 and around which the transfer tape T is wound. The neck portion 12 has an elongated form, and has an outer peripheral surface shape along sides of a substantially triangle in cross-section. During its use, the neck portion 12 is held with the tip sides of a thumb, an index finger, and a middle finger when the trunk portion 12 is held between the pads of the thumb and the index finger and between the bases of these fingers such that the rear end side of the trunk portion is projected to the back side of a user's hand, so that the dispenser 10 can be held in a similar manner as holding writing instruments.

### TECHNICAL FIELD

The present invention relates to a dispenser, and more particularly a dispenser capable of securely transferring coating films for correction or adhesive agents for adhesive-bonding to a surface to be transferred, even when the surface is a narrow region, when the coating films or the adhesive agents are transferred, by improving handling of the dispenser during use.

### BACKGROUND ART

Correction of characters and the like written on a paper surface can be performed by transferring a coating film for correction on an area where the correction is required, and by writing correct letters and the like on the transferred coating film. Dispensers or applicators for such correction have conventionally been commercially available. Such dispenser includes a case having a feeding portion and a reeling portion for a band-like tape in a roll form, the tape being laminated with a coating film for correction, and a head that is attached to the case and around which the tape is hung (for example, see Patent Document 1).
Patent Document 1: Japanese Patent Application Laid-Open No 2006-1236

### SUMMARY OF THE INVENTION

### Problems to be Solved by the Invention

The case of the dispenser, which is disclosed in Patent Document 1, includes a trunk portion, a neck portion continued to one end side of the trunk portion, and a head that is placed on the forward end side of the neck portion and around which the tape is hung.

However, the dispenser only includes the neck portion as a region for attaching the head. Thus, a user cannot hold the neck portion with the same feeling as holding writing instruments due to the small amount of a projection from the trunk portion. For this reason, when transferred, the dispenser needs to be held so as to grasp the trunk portion, and cannot be held with user's fingertips placed near the head side thereof. This leads to a disadvantage that it is difficult to transfer the coating film on an exact location in the case where an area to be transferred on a paper surface is a very complicated region.

The dispenser has another disadvantage that it is difficult to apply a pressing force necessary for the transferring because the neck portion is not suitable to be held with the fingertip sides, so that a good cut end of the coating film cannot be formed at a transfer start location and a transfer end location.

Further, another problem is present as follows: an unnecessary space tends to occur between the user's palm side and the trunk portion when the dispenser is held with a user's hand because the surface of the trunk portion is formed of flat surfaces, and in the case where the dispenser is loosely held, the dispenser is moved in the palm to prevent for stable holding of the dispenser, this also resulting in a factor causing poor transfer.

[Object of the Invention]

The invention is made in view of such disadvantages, and has its object to provide a dispenser adapted to enable stable holding thereof in the same manner as holding writing instruments, and be capable of easily and accurately performing transfer even in a complicated region when the coating film for correction and the like is transferred on a surface to be transferred.

### Means to Solve the Problems

To achieve the above object, the invention adopts the following configuration, i.e. a dispenser including: a case including a trunk portion and a neck portion, the trunk portion having an interior space for storing a transfer tape, and the neck portion being continued to one end side of the trunk portion and formed so as to gradually narrow; and a transfer head that is placed on the forward end side of the neck portion and around which the transfer tape is wound; and

wherein the neck portion has an outer peripheral surface shape along sides of a substantially triangle in cross-section.

In the dispenser according to the invention, the neck portion can be held in the substantially same position as the position in which writing instruments are held when the trunk portion is held between the pads of a thumb and an index finger and between the bases of these fingers such that the rear end side of the trunk portion is projected to the back side of a user's hand.

Moreover, the neck portion is held in place between tip sides of a thumb, an index finger, and a middle finger and about the first joints of these fingers when the trunk portion is held between the pads of the thumb and the index finger and between the bases of these fingers such that the rear end side of the trunk portion is projected to the back side of a user's hand.

Further, a curved recess portion preferably is formed on the outer periphery of the neck portion.

Moreover, the trunk portion includes a curved outer peripheral surface along an inner periphery formed between the pads of a thumb and an index finger and of the bases of these fingers when the trunk portion is held between the pads of the thumb and the index finger and between the bases of these fingers such that the rear end side of the trunk portion is projected to the back side of a user's hand, wherein the trunk portion includes the curved outer peripheral surface along the inner periphery formed between the pads of the thumb and the index finger and of the bases of these fingers.

Further, the invention may use the following configuration, i.e. a dispenser comprising: a trunk portion having an interior space for storing a transfer tape; and a transfer head that is placed on the forward end side of the trunk portion and around which the transfer tape is wound; and wherein the trunk portion has an outer peripheral surface shape along sides of a substantially triangle in cross-section.

In the present specification, terms which denotes a location or direction is used with reference to FIG. 2, herein, unless otherwise stated. The left side in FIG. 2 is defined as “fore” or “forward”, while the right side is defined as “rear”. A term “first joint” is used for a joint on the side close to a fingertip.

### Effects of the Invention

According to the invention, since the neck portion has an outer peripheral surface shape along sides of a substantially triangle in cross-section, it is possible to effectively prevent rotation in a circumferential direction to realize the stable holding thereof when the neck portion is held with a plurality of fingertips. Therefore, a user can transfer the coating film for correction and the like in a precise location, while maintaining a posture in which a tip edge of the head and a paper surface are mutually substantially parallel to each other.

Moreover, the configuration having the recess portion on the outer periphery of the neck portion can prevent a disadvantage that the fingertips slide to the head side when a pressing force is applied on the paper surface side when transferred. From this point of view, also, stable transfer can be performed.

Further, the trunk portion has the curved outer peripheral surface shape, and therefore this does not cause a disadvantage that the trunk portion moves in the palm.

### BRIEF DESCRIPTION OF THE DRAWINGS

FIG. 1 is a schematic plan view of a dispenser according to an embodiment;

FIG. 2 is a schematic front view of the dispenser;

FIG. 3 is a right side view of FIG. 1;

FIG. 4 is an end view along line A-A of FIG. 1;

FIG. 5 is a schematic perspective view showing a position in which the dispenser is held;

FIG. 6 is a schematic perspective view showing a held position when the dispenser is seen from the transfer head side; and

FIG. 7 is a schematic perspective view showing a position when the held dispenser is seen from the back side of a user's hand.

### DESCRIPTION OF REFERENCE NUMERAL

10 dispenser

11 trunk portion

12 neck portion

13 case

14 transfer head

28 recess portion

30 inclined surface

T transfer tape

### BEST MODE FOR WORKING THE INVENTION

An embodiment of the present invention will be described in detail below with reference to the drawings.

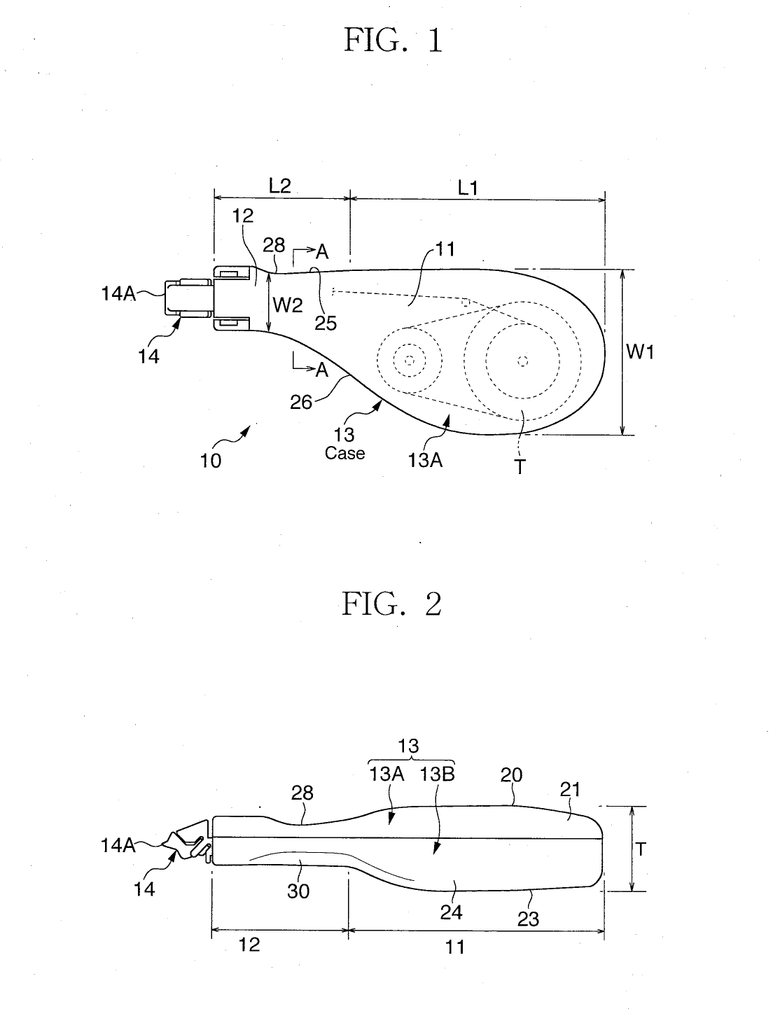

FIG. 1 shows a schematic plan view of a dispenser according to the present embodiment. FIG. 2 shows a front view thereof. In these drawings, a dispenser 10 comprises a case 13 including a trunk portion 11 and a neck portion 12, the trunk portion 11 having an interior space for storing a transfer tape T laminated with a coating film for correction on one side of a band-like sheet or tape and the neck portion 12 being continued to one end side of the trunk portion 11 and formed so as to gradually narrow, as well as a transfer head 14 that is placed on the forward end side of the neck portion 12 and around which the transfer tape T is wound. The trunk portion 11 and the neck portion 12 are not distinguished from each other by a distinct boundary such as difference in level. However, a region, where an area from a site near the first joints of a thumb, an index finger, and a middle finger to user's fingertips are roughly located, corresponds to the neck portion 12, when the trunk portion 11 is held between the pads of the thumb and the index finger and between the bases of these fingers such that the rear end side of the trunk portion is projected to the back side of a user's hand as described below.

The case 13 comprises an upper case 13A and a lower case 13B, as shown in FIG. 2. The upper case 13A includes an upper wall 20, and an upper peripheral wall 21 continued to an outer periphery of the upper wall 20. On the other hand, the lower case 13B includes a lower wall 23, and a lower peripheral wall 24 continued to an outer periphery of the lower wall 23. The upper peripheral wall 21 and the lower peripheral wall 24 are fitted to each other to form the case 13.

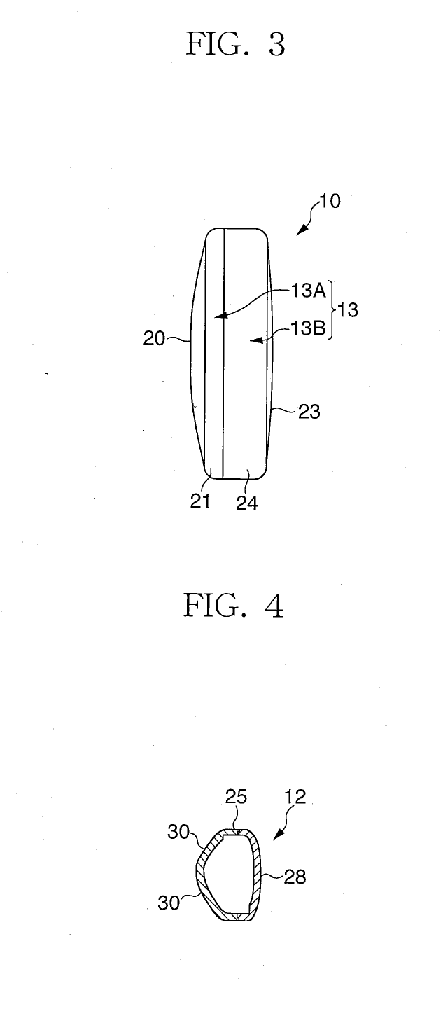

The trunk portion 11 has a shape which resembles an elliptical shape, in a planar shape, as shown in FIG. 1. The upper wall 20 and the lower wall 23, which form the trunk portion 11, have curved outer peripheral surface shapes, as shown in FIG. 3.

The neck portion 12, in a general appearance thereof, comprises a side wall portion 25 continued to a peripheral wall of the trunk portion 11 on the upper edge side thereof in FIG. 1, and on the other hand comprises a sloped portion 26 to be curved so as to gradually narrow a width dimension in the vertical direction in FIG. 1 of the trunk portion 11 on the lower edge side thereof. Moreover, the neck portion 12 comprises recess portions 28, 28 to be curved toward the upper edge side in FIG. 1 and the upper edge side in FIG. 2, respectively. In a lower part side in FIG. 2, the neck portion 12 includes, a pair of inclined surfaces 30 in which a center portion thereof is located outward, so that the neck portion 12 is configured to have an outer peripheral surface shape along sides of a substantially triangle in cross-section.

The transfer head 14 is attached in a state which a tip edge 14A is along a direction perpendicular to a paper surface in FIG. 2. Although the illustration of its detailed structure is omitted herein, thus, the transfer tape T in a roll form stored in the case 13 is guided so as to twist the surface of the tape about 90 degree on the feed path of the tape T, and wound around the transfer head 14.

In the embodiment, the case 13 is one having the following size: the maximum width W1 of about 39 mm in the vertical direction of the trunk portion 11 in FIG. 1 and a length L1 of about 62 mm in the horizontal direction of the trunk portion 11 in FIG. 1; the minimum width W2 of about 15 mm in the vertical direction of the neck portion 12 and a length L2 of about 30 mm in the horizontal direction of the neck portion 12; and the maximum thickness T of about 19 mm in the vertical direction in FIG. 2.

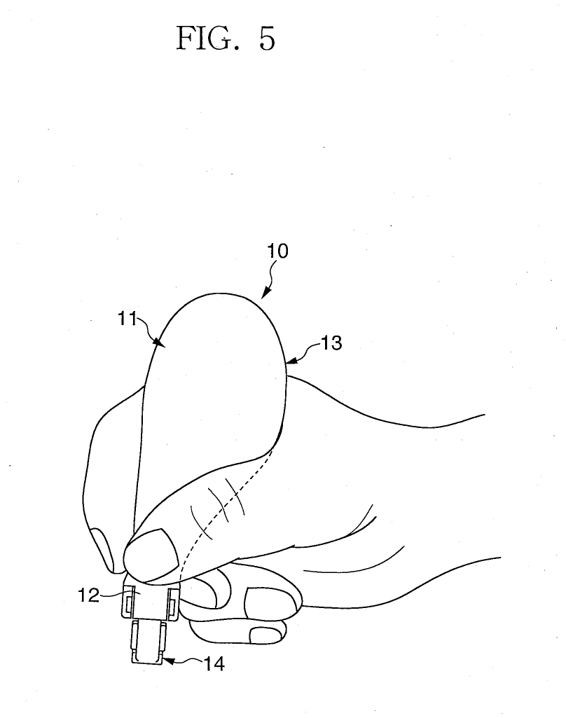

The method for using the dispenser 10 in the embodiment will be now described with reference to FIGS. 5 to 7.

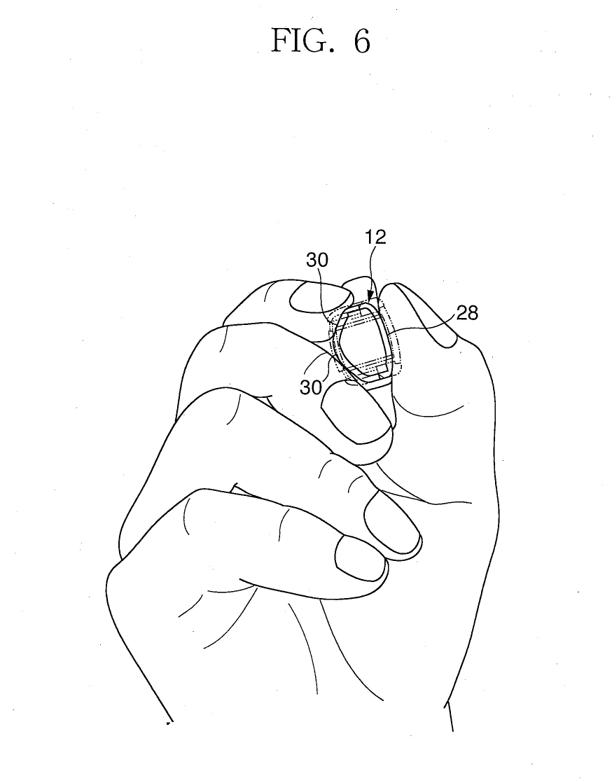

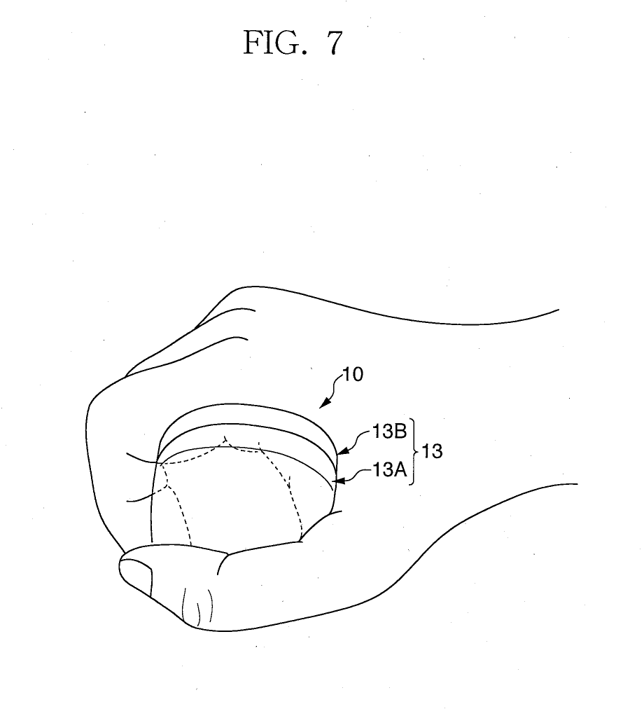

As shown in FIGS. 5 and 7, when a user holds the dispenser 10 with a user's hand, the trunk portion 11 is held between the pads of a thumb and an index finger and between the bases of these fingers such that the rear end side of the trunk portion 11 is projected to the back side of the user's hand. Then, the neck portion 12 is held in place between tip sides of the thumb, the index finger, and a middle finger and about the first joints of these fingers. On the other hand, as shown in FIG. 6, in outer peripheral side surfaces of the neck portion 12, the pad of the tip side of the thumb is in contact with the recess portion 28, while each of the index and the middle fingers is in contact with the inclined surface 30. Thus, the dispenser 10 is held in the substantially same position as the position in which writing instruments are held.

In the position where the dispenser 10 is held in this, manner, the tip 14A of the transfer head 14 is located in a plane generally parallel to the case 13, as shown in FIG. 5. Therefore, in such a position, the tip 14A of the transfer head 14 can be pushed against the paper surface and slid in a direction perpendicular to the paper surface in FIG. 5 to transfer the coating film of the transfer tape T onto the surface side of papers. Description of structures for feeding and reeling the transfer tape T is omitted because the structures are the substantially same as publicly known structures and are not the gist of the invention.

According to this embodiment, the position when the user holds the dispenser 10 with the user's hand is a position similar to a position in which writing instruments are held, so that the user has no feeling of strangeness during its use, as well as can slide the transfer head 14 in its stable position and keep the tip 14A in an easily viewable location. Therefore, this produces an effect that the user can perform a transfer with good precision even when a region to be transferred is a complicated and narrow area.

Although the best configuration, method, and the like for carrying out the invention have been disclosed in the above description, the invention is not limited thereto.

Thus, the invention has been particularly illustrated and described mainly in terms of a specific embodiment, but those skilled in the art may make various modifications to the embodiments described above in term of shapes, materials, quantities, and other detailed configurations without deviating from the scope of a technical idea and an object of the invention.

Accordingly, the description limiting the shapes, materials and the like disclosed above is described as an example in order to facilitate understanding of the invention, and is not intended to limit the invention. Therefore, the descriptions of parts name without part or all of the limiting of the shapes, materials and the like are within the invention.

Dimensional conditions of the embodiment described above, for example, are only illustrated for facilitating understanding of the invention, and is not intended to limit the structure of the invention. Thus, it is only necessary to provide the invention so as to be able to stably hold the neck portion 12 in a region on the fingertip side.

Moreover, in the embodiment described above, although the invention has been illustrated and described as the dispenser for transferring the coating film, the invention may be also applied to dispensers and the like for transferring an adhesive agent.

Further, in the above embodiment, although the trunk portion 11 has been illustrated and described to have a planar shape which resembles an elliptical shape, the shape of the trunk portion 11 may be modified. In this instance, for example, the trunk portion 11 may be provided in a tubular shape which extends linearly, so as to have an outer peripheral surface shape along sides of a substantially triangle in cross-section. Alternatively, the trunk portion 11 may be provided in a tubular shape which gradually narrows the trunk portion 11 toward the forward end, so as to have a similar outer peripheral surface shape in cross-section. Moreover, a formed part having the outer peripheral surface shape along sides of a substantially triangle may be at least provided only on the outer peripheral surface on the forward end side of the trunk portion where the fingertip side is located.

1. A dispenser comprising: a case including a trunk portion and a neck portion, the trunk portion having an interior space for storing a transfer tape, and the neck portion being continued to one end side of the trunk portion and formed so as to gradually narrow; and a transfer head that is placed on the forward end side of the neck portion and around which the transfer tape is wound; and
wherein the neck portion has an outer peripheral surface shape along sides of a substantially triangle in cross-section.

2. The dispenser according to claim 1, wherein the neck portion can be held in the substantially same position as the position in which writing instruments are held when the trunk portion is held between the pads of a thumb and an index finger and between the bases of these fingers such that the rear end side of the trunk portion is projected to the back side of a user's hand.

3. The dispenser according to claim 1, wherein the neck portion is held in place between tip sides of a thumb, an index finger, and a middle finger and about the first joints of these fingers when the trunk portion is held between the pads of the thumb and the index finger and between the bases of these fingers such that the rear end side of the trunk portion is projected to the back side of a user's hand.

4. The dispenser according to any one of claims 1 to 3, wherein a curved recess portion is formed on the outer periphery of the neck portion.

5. The dispenser according to claim 4, wherein the trunk portion comprises a curved outer peripheral surface along an inner periphery formed between the pads of a thumb and an index finger and of the bases of these fingers when the trunk portion is held between the pads of the thumb and the index finger and between the bases of these fingers such that the rear end side of the trunk portion is projected to the back side of a user's hand.

6. A dispenser comprising: a trunk portion having an interior space for storing a transfer tape; and a transfer head that is placed on the forward end side of the trunk portion and around which the transfer tape is wound; and
wherein the trunk portion has an outer peripheral surface shape along sides of a substantially triangle in cross-section.
